(19) United States
(12) Patent Application Publication
(10) Pub. No.: US 2021/0283667 A1
(43) Pub. Date: Sep. 16, 2021

(54) Systems and Methods for Cleaning and Maintenance of Tanks

(71) Applicants: Matthew COLE, Irvine, CA (US); Michael CAPPELLO, Irvine, CA (US); Grant KOEHAN, Irvine, CA (US); Mark STAUDER, Irvine, CA (US); Richard Thomas ARCHULETA, Greeley, CO (US); KURION, INC., Irvine, CA (US)

(72) Inventors: Matthew Cole, Westminster, CO (US); Michael Cappello, Westminster, CO (US); Grant Keohan, Westminster, CO (US); Mark Stauder, Westminster, CO (US); Richard Thomas Archuleta, Greeley, CO (US)

(21) Appl. No.: 17/257,566

(22) PCT Filed: Jul. 2, 2019
(86) PCT No.: PCT/US2019/040397

§ 371 Date: Jan. 1, 2021

Related U.S. Application Data
(60) Provisional application No. 62/806,781, filed on Feb. 16, 2019.
(60) Provisional application No. 62/693,309, filed on Jul. 2, 2018.

(51) Int. Cl. B08B 9/093; B60P 3/30; B60S 3/00

(52) U.S. Cl. CPC B08B 9/093; B60P 3/30; B08B 2203/0247; B08B 2209/08; B60S 3/008

(57) ABSTRACT

A manipulator boom assembly for releasable attachment to a manway of a tank. The manipulator boom assembly includes an elongated and curved boom defining an arcuate shape along a length of the boom, a base adapted to be releasably mounted to the manway of the tank, and a drive coupled to the boom, where the boom is movable by the drive relative to the base and the manway between a retracted position and an extended position within the tank.

### CROSS-REFERENCE TO RELATED APPLICATION(S)

This application is a continuation of U.S. Provisional Patent Application No. 62/806,781, filed on Feb. 16, 2019, and U.S. Provisional Patent Application No. 62/693,309, filed on Jul. 2, 2018, the entire contents of each of which are incorporated by reference herein.

### TECHNICAL FIELD

This disclosure relates generally to systems and methods of cleaning tanks, including the cleaning rail car tanks without requiring user entry into the tank.

### BACKGROUND

Tank cleaning can often be a labor-intensive and sometimes dangerous activity. By way of example, rail tank car cleaning is typically performed by a three-person team and requires confined space entry to meet OSHA requirements for working in such a hazardous environment. The work is often performed using a vacuum truck that sucks sludge from the tank while high pressure water is manually applied to all internal surfaces until clean. In rail tank car and other tank cleaning operations, it is desirable to have a remotely-operated solution that can perform the cleaning faster than conventional manual processes, and that does not require workers to enter the tanks, thus eliminating the hazards associated with confined space entry.

### SUMMARY

It is desirable to find alternate solutions that reduce the manual human-hours involved in tank cleaning, and that does not require crew members to enter the tanks, thus improving safety. New systems and methods that allow such work to be performed remotely and by fewer people (thereby reducing operation costs) are also welcome additions to this technology.

Accordingly, provided herein are systems and methods of cleaning and maintaining tanks. In some embodiments, the system includes a cleaning assembly having a base configured to support the cleaning assembly on a tank, a manipulator boom movable relative to the base and extendable into the tank, a manipulator arm positioned on an end of the manipulator boom and including a nozzle and a camera, wherein the manipulator arm is movable relative to the manipulator boom and including a joint configured to adjust the orientation of the nozzle, and a boom crane configured to hoist the cleaning assembly onto the tank.

Also provided herein is a manipulator boom assembly for releasable attachment to a manway of a tank. The manipulator boom assembly includes an elongated and curved boom defining an arcuate shape along a length of the boom, a base adapted to be releasably mounted to the manway of the tank, and a drive coupled to the boom, where the boom is movable by the drive relative to the base and the manway between a retracted position and an extended position within the tank.

Also provided herein is a method of cleaning a tank having a compartment for transporting materials and an opening to the compartment. The method includes mounting a base to the tank at the opening, at least partially supporting an elongated and curved boom with the base, the boom defining an arcuate shape along a length of the boom, moving the boom to different positions with respect to the base, and moving an end of the boom through an arcuate path within the compartment by moving the boom with respect to the base.

Also provided herein is a cleaning assembly for a tank having an opening, the tank also having inside surfaces at least partially defining a compartment for transporting materials. The cleaning assembly includes a base adapted to be releasably mounted to the tank at the opening, a drive, an arcuate boom coupled to the drive and base, and movable by the drive to different positions with respect to the compartment, a manipulator arm carried by a first end of the boom, where the manipulator arm includes a first joint having a first axis of rotation and a second joint having a second axis of rotation oblique with respect to the first axis of rotation, and a nozzle carried by the manipulator arm and through which cleaning fluid is discharged toward the inside surfaces of the tank.

### BRIEF DESCRIPTION OF THE DRAWINGS

A more complete understanding of the systems, methods, processes, and/or apparatuses disclosed herein may be derived by referring to the detailed description when considered in connection with the following illustrative figures. In the figures, like-reference numbers refer to like-elements or acts throughout the figures.

FIG. 1 illustrates a tank cleaning system and a tank according to one embodiment of the present invention.

FIG. 2 illustrates a tank cleaning system and a tank according to another embodiment of the present invention.

FIG. 3 illustrates a boom crane for use with a tank cleaning system according to one embodiment of the present invention.

FIG. 4 illustrates the tank cleaning system of FIG. 1 with the tank removed.

FIG. 5 illustrates a control system for use with a tank cleaning system according to one embodiment of the present invention.

FIG. 6A illustrates a cleaning assembly according to an embodiment of the present invention, shown in a retracted position.

FIG. 6B illustrates the cleaning assembly of FIG. 6A, shown in an extended position.

FIG. 7 illustrates a detailed view of a cleaning assembly according to an embodiment of the present invention, shown positioned in a manway of a tank.

FIGS. 8-12 illustrate the cleaning assembly of FIG. 7, shown in different stages of a cleaning operation.

FIG. 13 is a detailed view of a manipulator boom according to an embodiment of the present invention.

FIG. 14 is a detailed view of portions of a cleaning assembly according to an embodiment of the present invention.

FIG. 15 is a detailed view of the base of the cleaning assembly shown in FIG. 14.

FIG. 16 is a cross-sectional view of the inside of a tank, with the cleaning assembly of FIGS. 14 and 15 extending into the manway of the tank.

FIG. 17 is a perspective view of the manipulator boom of FIGS. 14-16, shown oriented at an angle relative to the plate of the base.

FIG. 18 is another perspective view of the manipulator boom of FIGS. 14-16, shown oriented at an angle relative to the plate of the base.

FIG. 19 is a detailed view of a manipulator arm according to one embodiment of the present invention.

FIG. 20 is another detailed view of the manipulator arm of FIG. 19.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and/or apparatuses disclosed herein may be practiced. It is to be understood that other embodiments may be utilized and structural and functional changes may be made without departing from the scope of the present invention.

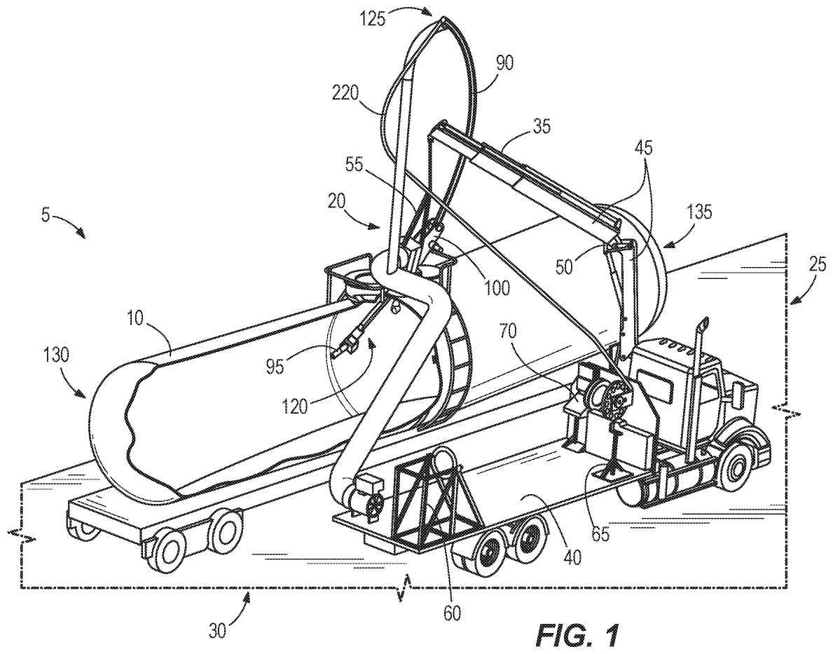

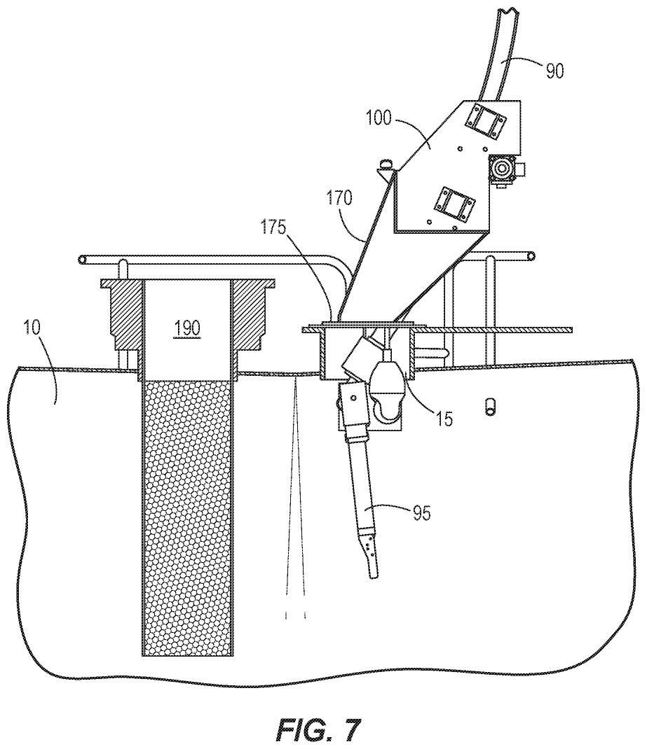

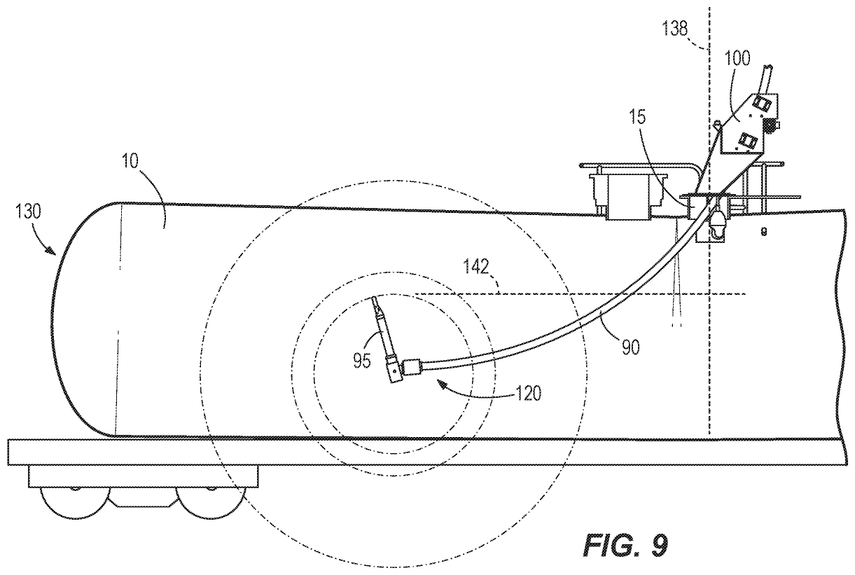

FIG. 1 illustrates one embodiment of a tank cleaning system 5. The cleaning system 5 may be used to clean various types of tanks 10, such as train rail tanks 10, truck tanks 10, etc., which include a manway 15 (see FIGS. 7-12) to enter the tank 10. The illustrated cleaning system 5 includes a cleaning assembly 20, a lift assembly 25, and a ventilation assembly 30, among other components.

The illustrated cleaning assembly 20 is a top-mounted cleaning system 5 that may extend into the tank 10 using a manway 15 on a top side of the tank 10. The illustrated cleaning assembly 20 is hoisted on top of the tank 10 by a lift assembly 25 and positioned on the manway 15 of the tank 10. In the embodiment shown in FIG. 1, the lift assembly 25 includes a knuckle boom truck that utilizes a knuckle boom crane 35 to hoist the cleaning assembly 20 above the tank 10 for positioning and suspending the cleaning assembly 20 with respect to (e.g., over and into) the manway 15. However, in other embodiments, alternative types of lift assemblies may be utilized. The cleaning assembly 20 and the lift assembly 25 are transportable by a vehicle, in this case, on the boom truck. In some embodiments, the cleaning assembly 20 is transported on the same vehicle as the lift assembly 25. In other embodiments, the cleaning assembly 20 is transported on a separate vehicle from the lift assembly 25.

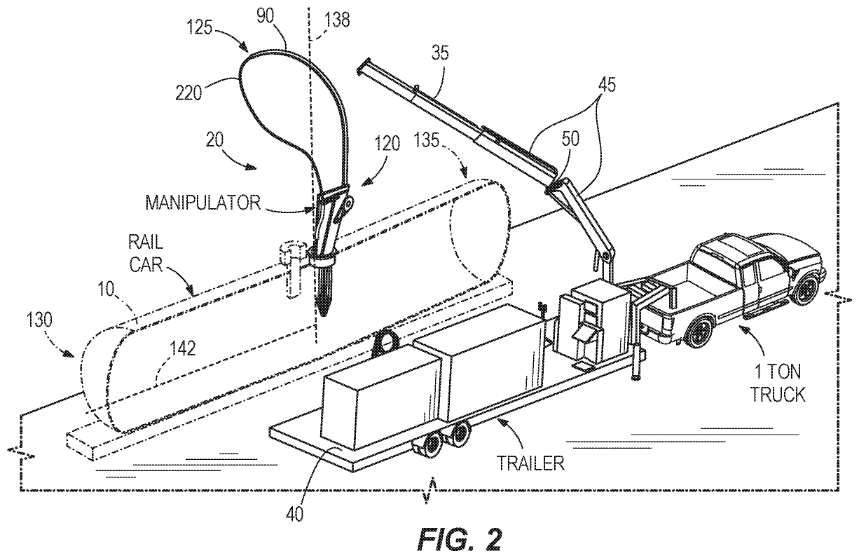

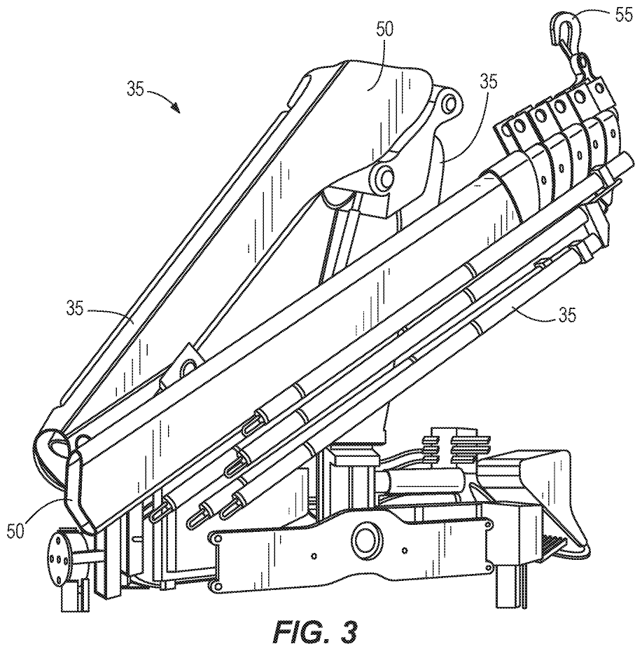

FIGS. 1 and 2 provide two different styles of lift assemblies that may be used. The lift assembly 25 shown in FIG. 1 includes a semi-truck with an open truck bed 40 that supports a boom crane 35. The lift assembly 25 of FIG. 2 includes a pick-up truck configured to tow an open truck bed 40 that supports a boom crane 35. FIG. 3 provides a detailed view of one embodiment of a boom crane 35 for use in the lift assembly 25. The illustrated boom cranes 35 includes a plurality of arms 45 (see FIGS. 1 and 2) connected at joints 50, which enable the boom crane 35 to fold or expand between a stowed configuration and an operational configuration. One or more of the arms 45 of the boom crane 35 may be telescoping, such that the arm 45 can extend or retract in order to provide additional extension of the arm 45. The boom crane 35 includes an attachment member 55 (e.g., see FIG. 1) configured to releasably couple to the cleaning assembly 20 to lift the cleaning assembly 20 onto the tank 10. In the illustrated embodiment of FIG. 1, the attachment member 55 is a hook. However, in other embodiments, the attachment member 55 may include other types of attachment mechanisms, such as a belt or pulley system, or any other mechanism capable of connecting to the cleaning assembly 20.

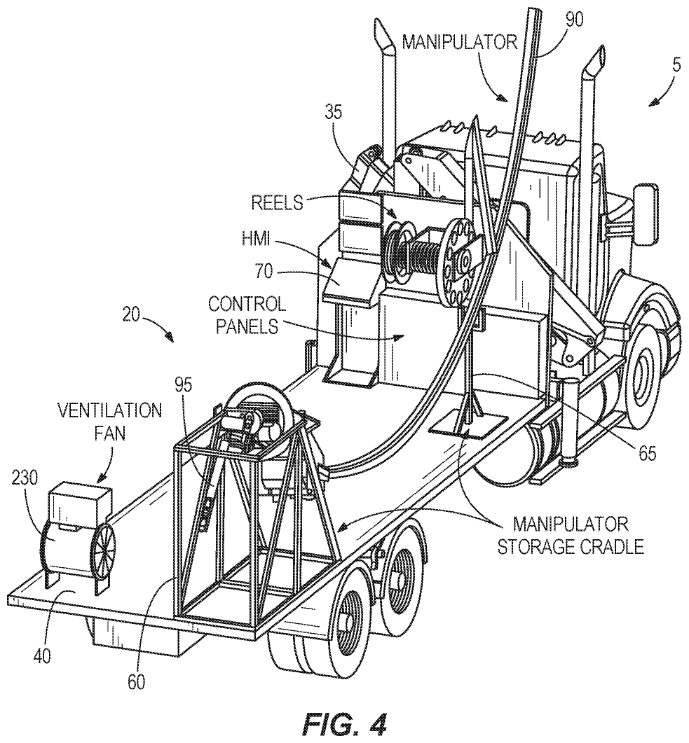

With reference to FIG. 4, the truck bed 40 may hold other components of the cleaning system 5. For example, the truck bed 40 may carry the lift assembly 25, the cleaning assembly 20 (when not in use), and/or the ventilation assembly 30. The illustrated truck bed 40 includes a storage cradle sized and shaped to support the cleaning assembly 20. In the illustrated embodiment, the storage cradle includes a first cradle 60 on one end of the truck bed 40 to support a first end of the cleaning assembly 20, and a second cradle 65 on another end of the truck bed 40 to support a second end of the cleaning assembly 20.

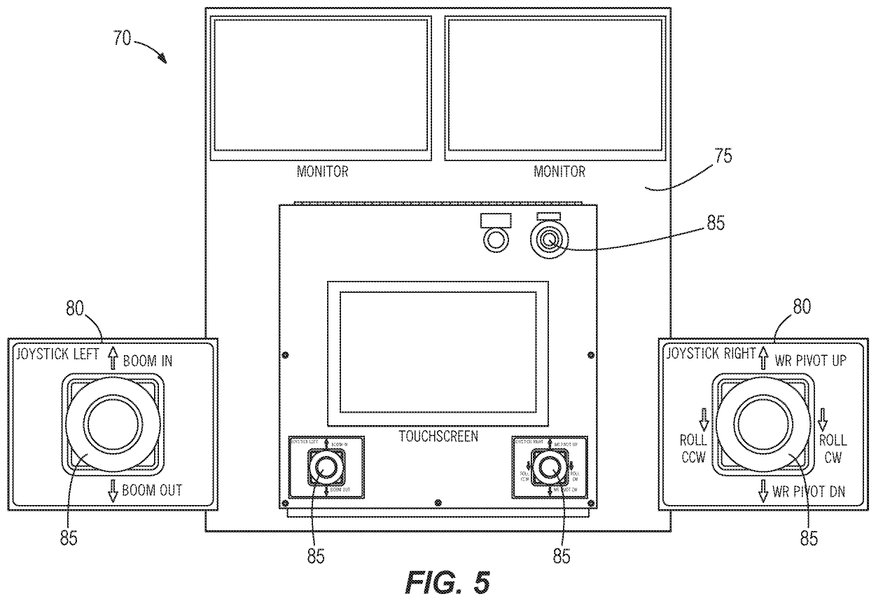

The illustrated truck bed 40 also includes a control system 70 for controlling the operation of at least some of the working components of the cleaning system 5. As shown in FIG. 5, in some embodiments the control system 70 includes a display screen 75 and a control panel 80 with one or more user-manipulatable controls. The display screen 75 enables a user to view the inside of the tank 10, and the control panel 80 includes joysticks, levers, or other user-manipulatable controls 85 that enable the user to operate the cleaning system 5. As will be described in greater detail herein, the illustrated control panel 80 includes joysticks 85, which enable a user to control the movement and operation of the lift assembly 25 and the cleaning assembly 20, although other suitable user-manipulatable controls such as levers, switches, buttons, and the like can also or instead be used for this purpose. In some embodiments, the display screen 75 may be a touch screen capable of providing additional user-manipulatable controls 85 or operational setting options. For example, the display screen 75 may provide a graphical user interface that enables the user to choose operational settings, cleaning parameters, etc.

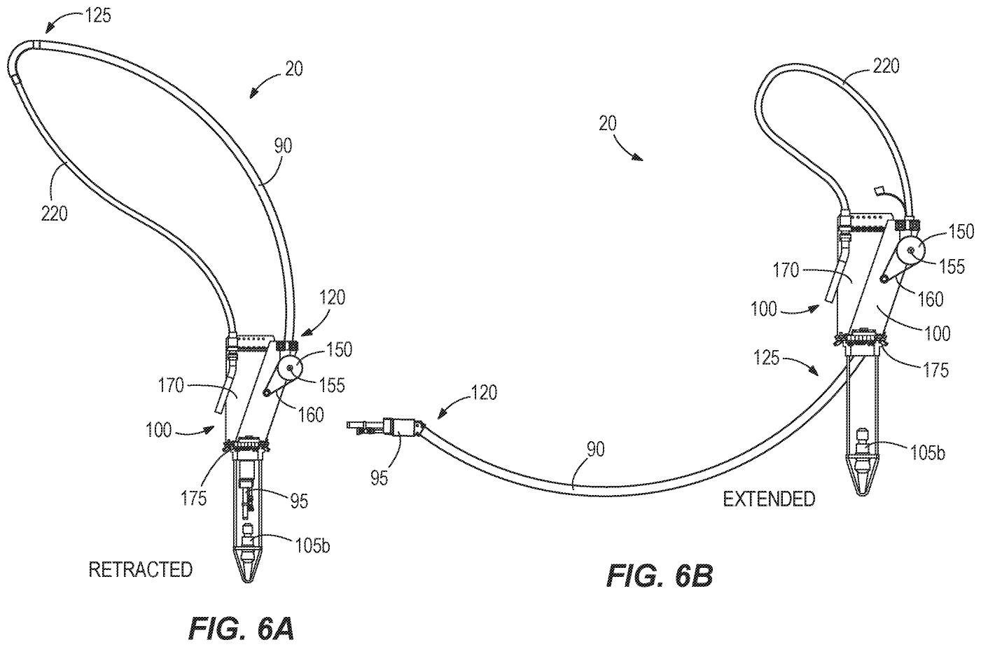

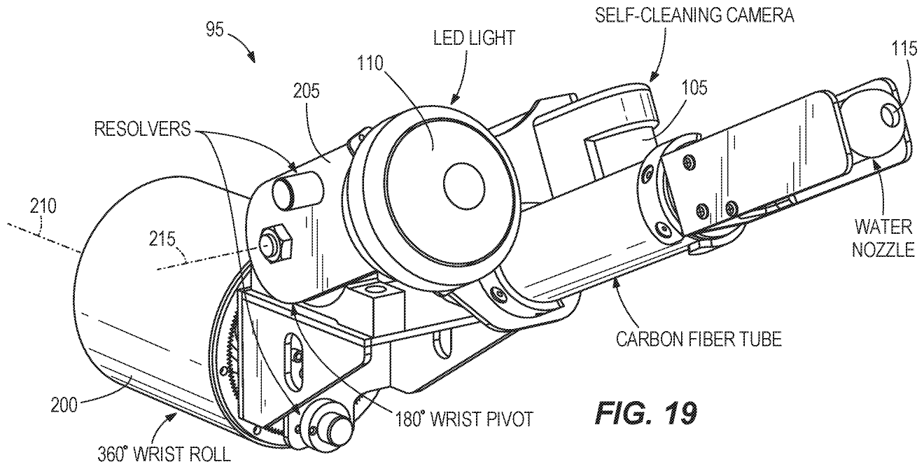

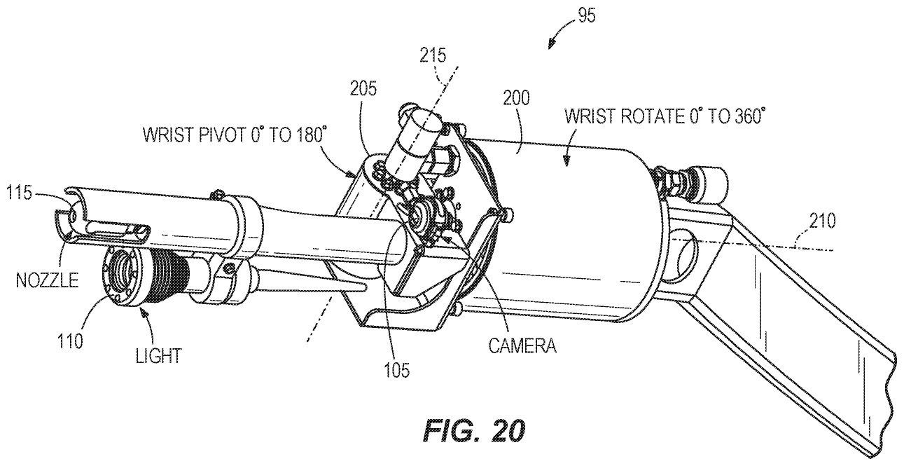

With reference the FIG. 6, the illustrated cleaning assembly 20 includes a manipulator boom 90, a manipulator arm 95, and a base 100. The base 100 is configured to be positioned on the manway 15 of the tank 10 to support the cleaning assembly 20 during cleaning operations. With reference also to FIGS. 19 and 20, the manipulator arm 95 includes a camera 105, a light 110, and a spray nozzle 115 for cleaning the inside of the tank 10. The manipulator boom 90 is movable relative to the base 100 to enter the manway 15 and extend into the tank 10. Specifically, the illustrated manipulator boom 90 supports the manipulator arm 95 on a first end 120 of the manipulator boom 90, and is operable to move the manipulator arm 95 throughout the inside of the tank 10. The illustrated manipulator boom 90 moves the manipulator arm 95 across the length of the tank 10, and the manipulator arm 95, in turn, moves relative to the manipulator boom 90 to direct cleaning fluid exiting the spray nozzle 115. For example, the manipulator boom 90 may move the manipulator arm 95 across the tank 10 towards an end of the tank 10 while the manipulator arm 95 directs the cleaning fluid in a forward direction (e.g., towards the first end 130 of the tank 10), in an upward or downward direction (towards the top of the tank 10 or the bottom of the tank 10, respectively), or towards a side wall of the tank 10. In some embodiments, the cleaning fluid may be a solvent. In some embodiments, diesel fuel may be use used as the cleaning fluid.

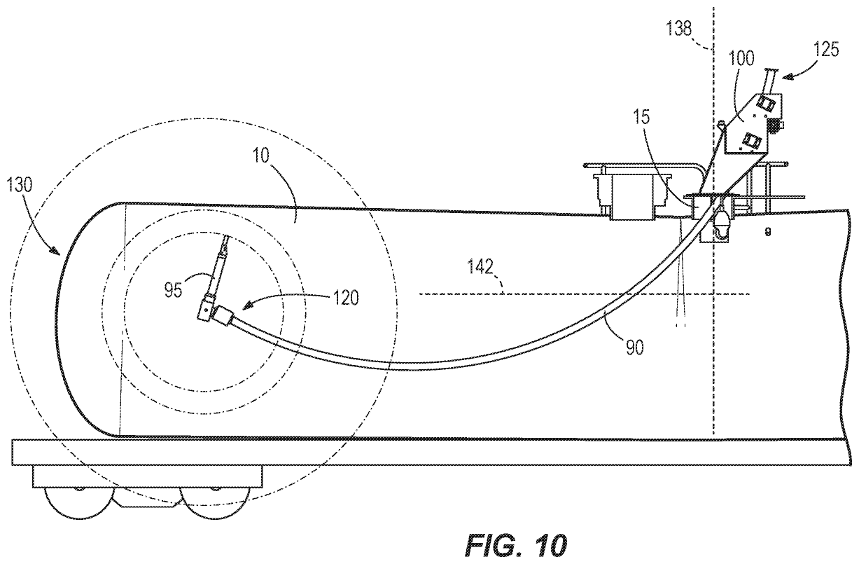

The manipulator boom 90 moves between a retracted state and an extended state. In a retracted state of the manipulator boom 90, the first end 120 of the manipulator boom 90 is closer to the base 100 than the second end 125. In an extended state the second end 125 of the manipulator boom 90 is closer to the base 100 than the first end 120. Furthermore, when the manipulator boom 90 is in the retracted state the second end 125 is positioned at a greater height above the base 100 relative to the height of the second end 125 when the manipulator boom 90 is in the extended position. For example, referring to FIGS. 2 and 10, a vertical axis 138 extends through the manway 15 of the tank 10 and can be used as a measure of the height of the second end 125 of the manipulator boom 90 relative to the base 100. When the manipulator boom 90 is in the retracted position, the second end 125 is at a greater height along the vertical axis 138 from the base 100 than when in the extended position.

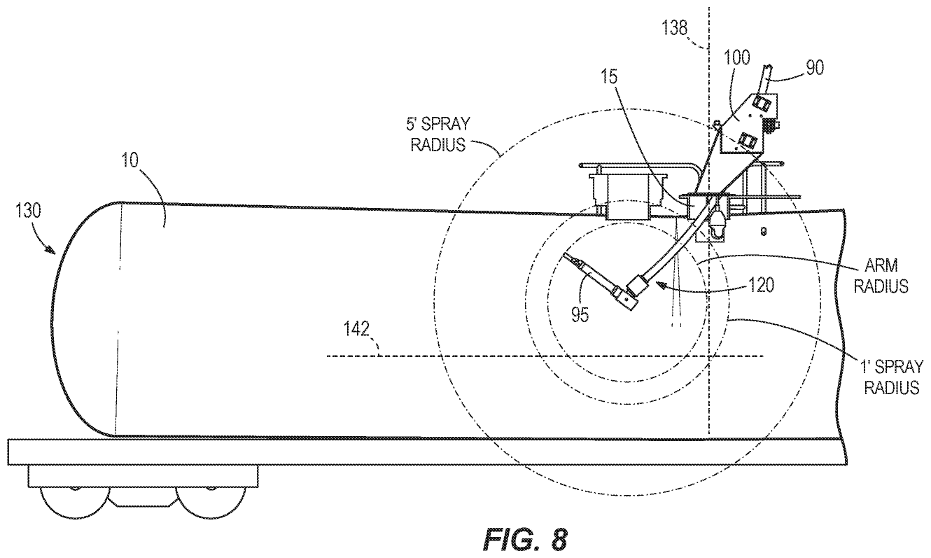

Similarly, when the manipulator boom 90 is in the retracted state the first end 120 is positioned at a closer horizontal distance from the base 100 relative to when the manipulator boom is in the extended position. For example, referring to FIGS. 8 and 10, a horizontal axis 142 extends perpendicular to the vertical axis 138 and can be used as a measure of the horizontal distance of the first end 120 of the manipulator boom 90 from the base 100. When the manipulator boom 90 is in the extended position, the first end 120 is at a greater distance along the horizontal axis 142 from the base 100 than when in the retracted position.

Furthermore, the curved shape of the manipulator boom 90 enables the manipulator boom 90 to move in an arcuate path relative to the base 100 and manway 15. The first end 120 and the second end 125 of the manipulator boom 90 move in an arcuate path relative to the base 100 and manway 15. In other words, when the manipulator boom 90 is in a retracted position, the second end 125 wherein the boom is oriented at an oblique angle with respect to the vertical axis 138 in the extended position of the boom.

FIG. 6A shows the manipulator boom 90 in a fully retracted position relative to the base 100. In this position, the first end 120 of the manipulator boom 90 is positioned near or within the base 100 while the second end 125 of manipulator boom 90 is positioned away from the base 100. In this retracted position, the majority of the manipulator boom 90 is positioned above the base 100. In the retracted position, the manipulator boom 90 is primarily outside of the tank 10. FIG. 6B shows the manipulator boom 90 following insertion through the base 100 to a fully-extended position in which the second end 125 of the manipulator boom 90 is positioned near or within the base 100, while the first end 120 of the manipulator boom 90 is extended into the tank 10 and away from the base 100. In those applications in which the manway 15 is positioned in a central location of the tank 10 as shown in FIGS. 1 and 2, the manipulator boom 90 may move the manipulator arm 95 from the manway 15 to a first end 130 of the tank 10, and then (e.g., in another cleaning operation) from the manway 15 to a second end 135 of the tank 10.

FIGS. 7-12 illustrate some of the possible movements of the manipulator boom 90 and the manipulator arm 95 within the tank 10. FIG. 7 shows the base 100 secured to the manway 15 of the tank 10 with the manipulator boom 90 and the manipulator arm 95 in a generally retracted position. As discussed above, in the retracted position, the first end 120 of the manipulator boom 90 is positioned within or near the base 100, and the second end 125 of the manipulator boom 90 is positioned away from the base 100. The manipulator arm 95 is positioned just inside of the tank 10, and is directed in a downward direction to spray cleaning fluid towards the bottom of the tank 10.

FIGS. 8-10 show the manipulator boom 90 moving the manipulator arm 95 from a central portion of the tank 10 near the manway 15 towards a first end 130 of the tank 10. In each of these figures, the manipulator boom 90 translates (e.g, slides) relative to the base 100 and further into the tank 10 to move the manipulator arm 95 closer to the first end 130 of the tank 10. Furthermore, the manipulator arm 95 is directed in an upward direction to spray cleaning fluid towards the top of the tank 10. Although not illustrated in FIGS. 8-10, the manipulator arm 95 may be rotating to different orientations (e.g., in a downward direction, in either or both lateral directions, or in combinations of such directions) to spray different areas of the tank 10 (e.g., the bottom or sides of the tank 10) as the manipulator boom 90 moves the manipulator arm 95 towards the first end 130 of the tank 10. These manipulator arm 95 movements and spraying operations can also or instead occur as the manipulator boom 90 is moved in an opposite (i.e., retracting) direction with respect to the tank 10.

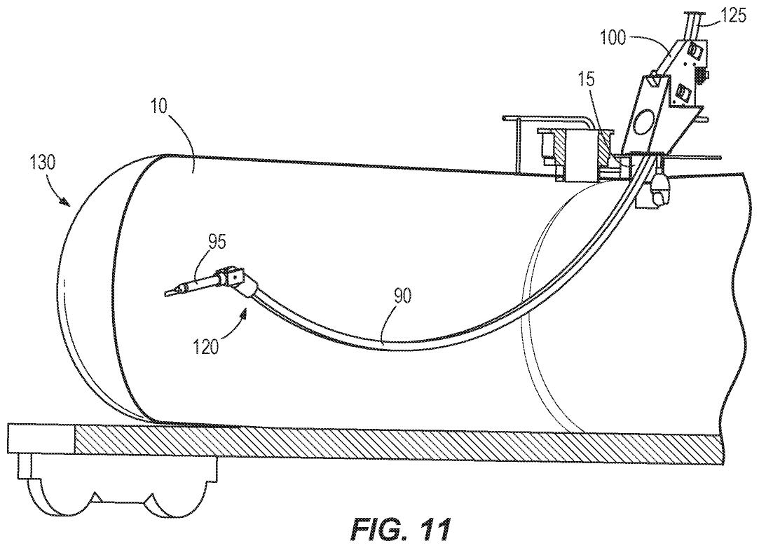

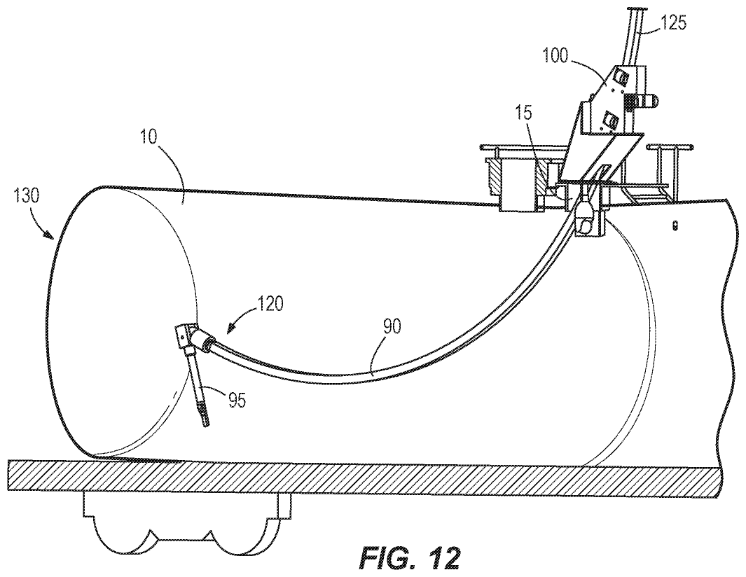

FIG. 11 shows the manipulator boom 90 in an extended position as it reaches the first end 130 of the tank 10. The manipulator boom 90 translates (e.g., slides) through the base 100 so that the second end 125 of the manipulator boom 90 is positioned proximate the base 100 and the first end 120 of the manipulator boom 90 approaches the first end 130 of the tank 10. The manipulator arm 95 is shown in a forward direction to direct fluid towards the first end 130 of the tank 10. FIG. 12 shows the manipulator boom 90 in a similarly-extended position with the manipulator arm 95 directed in a downward direction to direct cleaning fluid towards the bottom of the tank 10.

Once the portion of the tank 10 reachable by the manipulator boom 90 and manipulator arm 95 has been cleaned (e.g, the first half of the tank 10, in many rail car applications), the manipulator boom 90 may be retracted towards the manway 15. The base 100 may be rotated roughly 180 degrees to re-orient the cleaning assembly 20 to allow the manipulator boom 90 to extend towards the second end 135 of the tank 10. In some embodiments, the manipulator boom 90 is fully retracted before the base 100 is adjusted to face the second end 135 of the tank 10. However, in other embodiments, the manipulator boom 90 is only partially retracted before the base 100 is rotated to face the second end 135 of the tank 10. For example, the manipulator boom 90 may be retracted a sufficient amount to allow the manipulator boom 90 to rotate within the tank 10 without hitting a side wall or other internal structure of the tank 10. In some embodiments, the base 100 is automatically rotated to face the second end 135 of the tank 10. For example, the base 100 may be automatically rotated by a motor capable of turning the base 100. In other embodiments, the base 100 is manually rotated by the user operating the boom crane 35 to reorient the cleaning assembly 20. In still other embodiments, the manipulator boom 90 is either withdrawn from the base 100 and re-inserted in a new (e.g., 180-degree change) orientation with respect to the base 100, or is rotated within the base 100 to the new orientation.

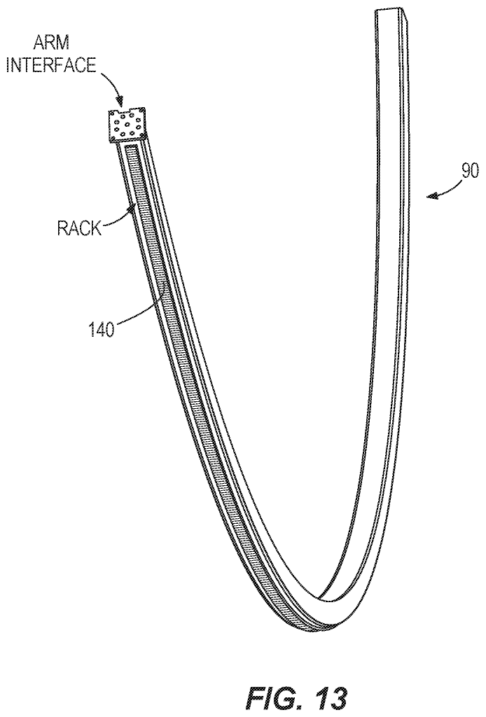

As shown in FIG. 13, the illustrated manipulator boom 90 has an arcuate shape, which allows the manipulator boom 90 to be inserted into and retracted out of the tank 10 as described above without complicated mechanical movements. The length of the manipulator boom 90 is defined by opposite ends (i.e., the first end 120 and the second end 125) of the manipulator boom 90. The arcuate shape extends along at least a majority of the length of the manipulator boom 90. For example, in some embodiments, the arcuate shape extends along at least 75% of the length of the manipulator boom 90. The illustrated manipulator boom 90 uses a steel 4″×4″ curved tube of continuous radius with a length of 25 feet. However, in other embodiments, the exact size and shape of the manipulator boom 90 may vary to accommodate different sized tanks 10. For example, the length of the manipulator boom 90 may vary depending on the length of the tank 10 being cleaned. Also, in some embodiments the shape (e.g., curvature) of the manipulator boom 90 can be changed by the user, such as by one or more joints located along the manipulator boom 90 that can be adjusted and then retained in place by suitable fasteners, by interference fits between segments of the manipulator boom 90, by tight friction interfaces between joint parts, and the like, by deformable materials of the manipulator boom 90 (e.g., repeatably deformable using one or more mandrels), or in other suitable manners.

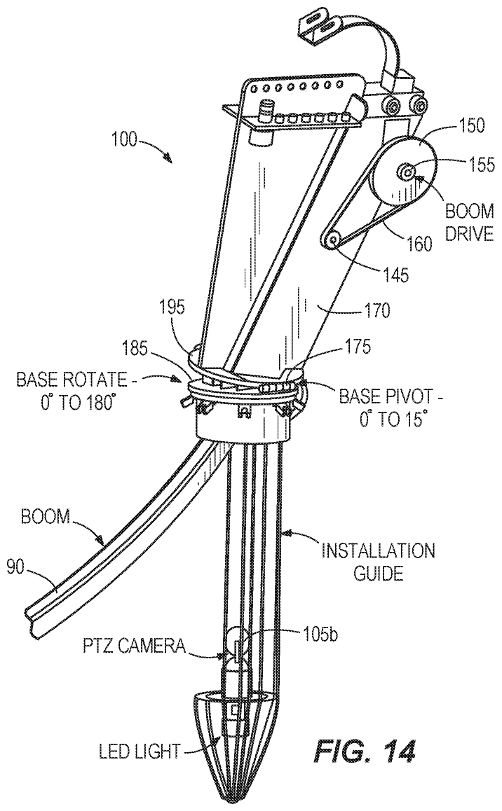

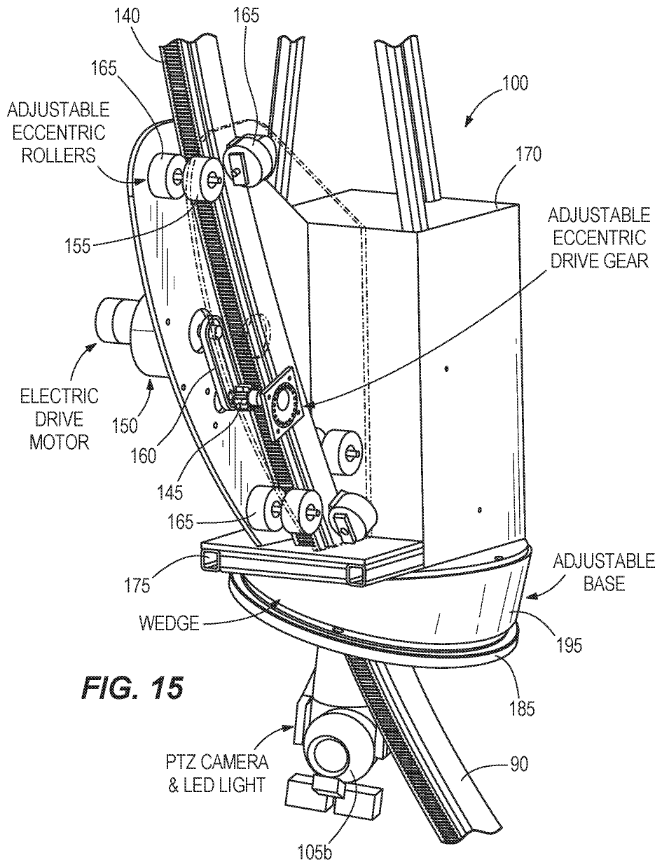

With reference to FIGS. 14-15, the illustrated manipulator boom 90 translates (e.g., slides) through the base 100, and into and out of the tank 10 by a rack 140 and gear mechanism employed between the manipulator boom 90 and the base 100. The manipulator boom 90 is a generally curved tube defining a raceway 142 along one side of the curved tube. The illustrated manipulator boom 90 includes a rack 140 extending along the raceway 142 in the manipulator book 90. The rack 140 includes a series of teeth 146 that are engaged by a toothed gear 145 (e.g., a pinion gear) in the base 100. The gear 145 is rotatably driven by a boom drive 150 on the base 100. In the illustrated embodiment, the boom drive 150 includes a motor 155 and a drive belt 160 that drive rotation of the gear 145 to ultimately move the manipulator boom 90 relative to the base 100, and thus, relative to the manway 15 when the base 100 is coupled to the manway 15. In other embodiments, other types of drive mechanism may be used to insert the manipulator boom 90 into the tank 10. Furthermore, the manipulator boom 90 may be supported by rollers 165 mounted to the base 100. The rollers 165 help support the manipulator boom 90 as it moves through the base 100. In the illustrated embodiment, the rollers 165 are passive rollers 165 that rotate as the manipulator boom 90 slides through the base 100. In other embodiments, one or more of these rollers 165 may be driven to assist with movement of the manipulator boom 90 relative to the base 100.

As previously described, the base 100 of the illustrated embodiments help support the cleaning assembly 20 on the tank 10 during cleaning operations. In some embodiments, the base 100 is removably coupled to the manway 15 to provide stability to the manipulator boom 90 and the manipulator arm 95 as they move into and within the tank 10. The illustrated base 100 includes a housing 170 and a support assembly 175. The illustrated manipulator boom 90 slides through both the housing 170 and the support assembly 175 during cleaning operations. With continued reference to FIGS. 14 and 15, the housing 170 includes the gear 145 that engages with the rack 140 on the manipulator boom 90 to thread the manipulator boom 90 into the tank 10. The housing 170 can also include the boom drive 150 for driving the gear 145, as well as the rollers 165 that support the manipulator boom 90.

Additionally, the housing 170 of the base 100 includes an attachment point 180 (FIG. 7) that can be grasped by the attachment member 55 on the boom crane 35 to hoist the cleaning assembly 20 above the tank 10. In the illustrated embodiment, the attachment point 180 on the base 100 is formed by an eye loop that can be grasped by the hook on the boom crane 35. Additionally, if the boom drive 150 fails and the manipulator boom 90 cannot be retracted by the boom drive 150, the entire cleaning assembly 20 can be withdrawn from the tank 10 by the boom crane 35.

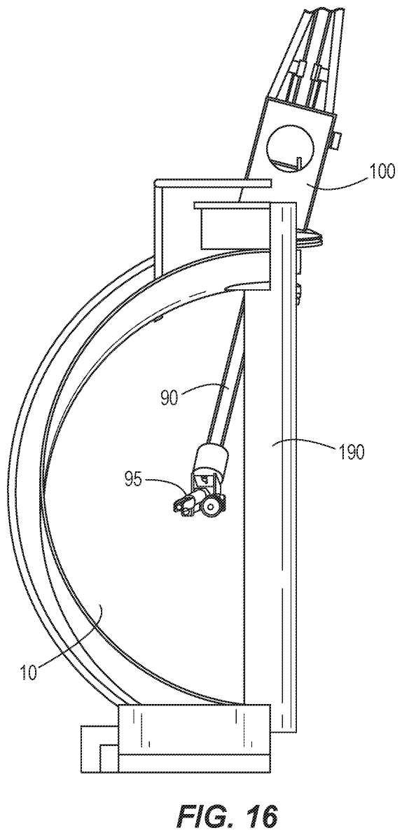

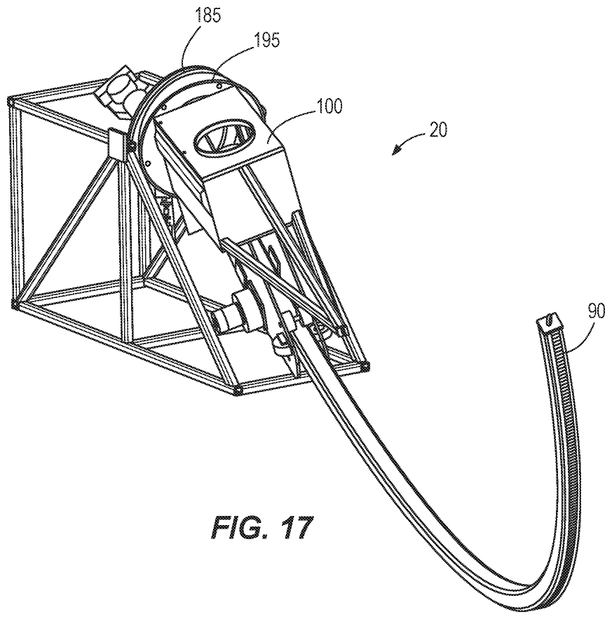

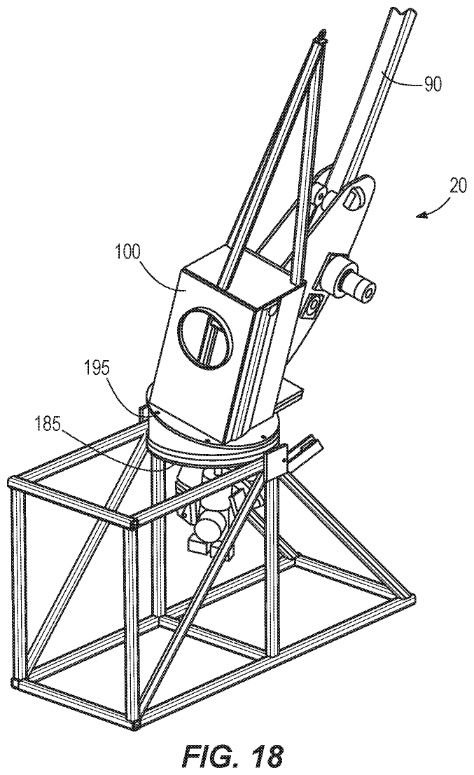

The illustrated support assembly 175 removably couples the cleaning assembly 20 to the tank 10. Once the illustrated boom crane 35 hoists the cleaning assembly 20 above the tank 10, the support assembly 175 is inserted into the manway 15 of the tank 10 to secure the cleaning assembly 20 to the tank 10 for cleaning operations. Specifically, as shown in the embodiment of FIGS. 14-15 by way of example, the support assembly 175 includes a plate 185 that is sized and shaped to mate with the manway 15. In the illustrated embodiment, the plate 185 is oriented at an angle relative to the manipulator boom 90 in order to thread the manipulator boom 90 into the tank 10 at an offset angle. Specifically, as shown in FIGS. 7 and 16, tanks 10 often include a sump tube 190 extending in a vertical direction from the bottom of the tank 10 to the top of the tank 10. In the illustrated embodiment, the sump tube 190 is positioned adjacent the manway 15. Accordingly, in order to allow the manipulator boom 90 to extend towards the end of the tank 10 without interference with the sump tube 190, the manipulator boom 90 is threaded into the tank 10 at an offset angle that allows the manipulator boom 90 to avoid the sump tube 190. FIGS. 17 and 18 provide an example of the manipulator boom 90 oriented at an angle relative to the plate 185.

In the illustrated embodiments, the offset angle of the plate 185 with respect to the manipulator boom 90 is accomplished by positioning a wedge 195 between the plate 185 and the housing 170. In some embodiments, the wedge 195 is adjustable to increase or decrease the angle of the plate 185 relative to the housing 170. The illustrated plate 185 is positioned on or in the manway 15 in an orientation that is generally parallel with the opening created by the manway 15. In other words, the plate 185 is oriented flat across the manway 15, and the housing 170 and the manipulator boom 90 are oriented at an angle relative the manway 15 by virtue of the shape of the wedge 195. Accordingly, as the manipulator boom 90 extends into the manway 15, the manipulator boom 90 will be oriented at an angle with respect to a vertical axis (i.e., a vertical axis that is orthogonal with respect to the ground) equivalent to the angle created by the wedge 195. When the tank 10 being cleaned does not include a sump tube 190, the base 100 need not necessarily include a wedge 195, or the wedge 195 may be replaced by a flat piece. Alternatively, in some embodiments, an adjustable wedge 195 may be used to maneuver the orientation of the manipulator boom 90 to achieve one or more optimal positions during cleaning operations.

With reference to FIGS. 19 and 20, the illustrated manipulator arm 95 includes the nozzle 115, the camera 105, and a light 110. The nozzle 115 can provide a high pressure wash for cleaning the inside of the tank 10. In the illustrated embodiment, the nozzle 115 is mounted to a carbon fiber tube to provide stability during cleaning. The camera 105 is positioned just behind the nozzle 115 in the illustrated embodiment to provide a direct line of sight of the cleaning fluid being sprayed by the nozzle 115. The camera 105 can include pan, zoom, and tilt capabilities to adjust the viewing angle of the camera 105. The illustrated camera 105 is a self-cleaning camera 105 that can be automatically washed during operations to ensure continuous viewing. For example, the camera 105 may include a wiper to clean the lens of the camera 105. In some embodiments, a second camera 105b is positioned on the base 100, or is suspended into the tank 10 from the base 100 to provide an additional angle for viewing the inside of the tank 10 (see FIG. 14). In those embodiments in which a second camera 105b is used, the second camera 105b may be manually deployed as needed during operation. The second camera 105b may also include pan, tilt and zoom capabilities. In the illustrated embodiment, the light 110 is an LED light 110 positioned adjacent the camera 105 to provide illumination for enhanced viewing.

The manipulator arm 95 of the illustrated embodiments includes two rotary joints 200, 205 for manipulation of the nozzle 115, camera 105, and light 110. A first joint 200 rotates about a first axis 210 of rotation and can provide for 360 degrees of rotation about the first axis 210. A second joint 205 is positioned downstream of the first joint 200, towards the camera 105. The second joint 205 rotates about a second axis 215 of rotation that is perpendicular to the first axis 210, and can provide 180 degrees of rotation about the second axis 215. In the illustrated embodiment, the joints 200, 205 are both hydraulic joints 200, 205. However, in other embodiments, one or both of the joints 200, 205 may include other types of actuators to enable rotation. In some embodiments, each joint on the manipulator arm 95 may provide position feedback to allow for automated movement control of the manipulator arm 95. For example, in some embodiments, the joints 200, 205 may use a resolver and ring gear connection to record revolutions.

The camera 105 and the light 110 are used to provide visual information for the user operating the cleaning assembly 20. As previously described, in some embodiments the control system 70 includes a display that enables the user to see the inside of the tank 10 and to maneuver the cleaning assembly 20. In some embodiments, the user can control both the camera 105 and the light 110 from the control assembly. For example, the user may be able to zoom, pan, or adjust the tilt of the camera 105 to customize the view. Likewise, the user may be able increase and decrease illumination of the light 110. In some embodiments, the control assembly may allow a user to conduct automated cleaning motions. For example, in the illustrated embodiment, there are four automated settings for each of the two joints 200, 205 on the manipulator arm 95. Each of the joints 200, 205 may be automatically assigned to rotate between 0-90 degrees, between 0-180 degrees, between 0-360 (for the first joint 200), or a custom range. Furthermore, a user may control the manipulator arm 95 to have each of the joints 200, 205 run through a series of automated movements within these ranges. In embodiments that include position feedback from the joints 200, 205, a user can monitor the live angle outputs from each joint and then set them to rotate to any range desired. Additional automated settings may be added to the cleaning systems 5. Automatic control of the manipulator arm 95 also enables the user to focus manual controls on lateral movement of the manipulator boom 90.

In the illustrated embodiments, the cleaning fluid expelled from the nozzle 115 is provided through a hose extending from a fluid supply on the truck bed 40. Likewise, the electronic components providing power and control signals to the manipulator boom 90 and the manipulator arm 95 are provided through a series of wires extending from the truck bed 40. Together the hose and the series of wires form a hose bundle 220 that extends from the truck bed 40, up to the second end 125 of the manipulator boom 90, and through the length of manipulator boom 90 to the appropriate end locations (i.e., depending on the specific wire or fluid line).

The cleaning systems 5 of the illustrated embodiments further includes the ventilation assembly 30, which includes a ventilation duct 225 and a fan 230. The ventilation duct 225 extends from the truck bed 40 to the base 100 of the cleaning assembly 20. The fan 230 is positioned on the truck bed 40 and draws air from the inside of the tank 10 to ventilate the inside of the tank 10. In other embodiments, the fan 230 is designed to blow clean air into the tank 10 are push contaminated air out of the tank 10. In some embodiments, the ventilation duct 225 may be a corrugated hose. However, in other embodiments different styles of ventilation ducts 225 may be used.

Various features and advantages of the invention are set forth in the following claims.

1. A manipulator boom control and cleaning system for releasable attachment to a manway of a tank, the system comprising:
an elongated and curved boom defining an arcuate shape along a length of the boom;
a base adapted to be releasably mounted to the manway of the tank;
a drive coupled to the boom, the boom movable by the drive relative to the base and the manway between a retracted position and an extended position within the tank;
a manipulator arm positioned on an end of the boom comprising a nozzle, wherein the manipulator arm is movable relative to the boom and wherein the manipulator arm comprises a joint configured to adjust orientation of the nozzle;
a camera, wherein the camera provides visual information for a user; and
a display screen and a control panel with one or more user-manipulatable controls, wherein the display screen enables the user to view camera images from the inside the tank, and wherein the control panel includes user-manipulatable controls that enable the user to operate the system.

2. (canceled)

3. The system of claim 1, wherein the elongated and curved boom includes a raceway extending along the boom and by which the boom is driven to move relative to the base and the manway.

4-5. (canceled)

6. The system of claim 1, wherein the arcuate shape extends along at least a majority of the length of the boom.

7-8. (canceled)

9. The system of claim 1, wherein the boom moves in an arcuate path relative to the base and manway responsive to being driven by the drive.

10-12. (canceled)

13. The system of claim 1, wherein the boom is oriented at an oblique angle with respect to a vertical axis in the extended position of the boom.

14. The system of claim 13, further comprising a wedge coupled to a housing of the base, the wedge orienting the boom at the oblique angle with respect to the vertical axis.

15. The system of claim 14, wherein the oblique angle of the boom relative to the vertical axis is adjustable.

16-38. (canceled)

39. A cleaning assembly system for a tank having an opening, the system comprising:
a base adapted to be releasably mounted to the tank at the opening;
a drive;
an arcuate boom coupled to the drive and the base, and movable by the drive to different positions within the tank;
a manipulator arm coupled to a first end of the arcuate boom, the manipulator arm including a first joint having a first axis of rotation and a second joint having a second axis of rotation oblique with respect to the first axis of rotation;
a nozzle coupled to the manipulator arm and through which a cleaning fluid is discharged toward one or more inside surfaces of the tank;
a camera, wherein the camera provides visual information for a user;
a display screen and a control panel with one or more user-manipulatable controls, wherein the display screen enables the user to view camera images from the inside the tank, and wherein the control panel includes user-manipulatable controls that enable the user to operate the system; and
a ventilation assembly comprising a ventilation duct and a fan, wherein the ventilation assembly at least one of draws contaminated air out of the tank and blows clean air into the tank.

40. (canceled)

41. The system of claim 39, wherein the arcuate boom includes a raceway extending along the boom and by which the boom is driven to move relative to the base and the opening.

42-43. (canceled)

44. The system of claim 39, wherein the arcuate shape extends along at least a majority of the length of the boom.

45-46. (canceled)

47. The system of claim 39, wherein the boom moves in an arcuate path relative to the base and opening responsive to being driven by the drive.

48-50. (canceled)

51. The system of claim 39, wherein the boom is oriented at an oblique angle with respect to a vertical axis in the extended position of the boom.

52. The system of claim 51, further comprising a wedge coupled to a housing of the base, the wedge orienting the boom at the oblique angle with respect to the vertical axis.

53. The system of claim 52, wherein the oblique angle of the boom relative to the vertical axis is adjustable.

54-58. (canceled)

59. The system of claim 1, further comprising a light coupled to the manipulator arm.

60. The system of claim 1, wherein user-manipulatable controls comprise one or more of a touchscreen, joystick, levers, switches, buttons, and graphical user interface.

61. The system of claim 1, further comprising a second camera coupled to the base or suspended into the tank from the base.

62. The system of claim 39, further comprising a light coupled to the manipulator arm.

63. The system of claim 39, wherein user-manipulatable controls comprise one or more of a touchscreen, joystick, levers, switches, buttons, and graphical user interface.

64. The system of claim 39, further comprising a second camera coupled to the base or suspended into the tank from the base.
